(19) United States
(12) Patent Application Publication
(10) Pub. No.: US 2023/0207800 A1
(43) Pub. Date: Jun. 29, 2023

(54) POSITIVE ELECTRODE, SECONDARY BATTERY, AND ELECTRONIC DEVICE

(71) Applicant: SEMICONDUCTOR ENERGY LABORATORY CO., LTD., Atsugi-shi (JP)

(72) Inventors: Kazuki TANEMURA, Isehara (JP); Yumiko YONEDA, Isehara (JP); Mayumi MIKAMI, Atsugi (JP); Kazutaka KURIKI, Ebina (JP)

(21) Appl. No.: 18/083,622

(22) Filed: Dec. 19, 2022

(30) Foreign Application Priority Data
Dec. 24, 2021 (JP) 2021-210209

(51) Int. Cl. H01M 4/525; H01M 4/66; H01M 10/0525

(52) U.S. Cl. CPC H01M 4/525; H01M 4/667; H01M 4/661; H01M 10/0525; H01M 2004/028

(57) ABSTRACT

To provide a positive electrode active material film that does not have a (003) orientation and has a layered rock-salt crystal structure even though an inexpensive substrate such as a glass substrate is used, and a positive electrode including the positive electrode active material film. The positive electrode includes a substrate, a positive electrode current collector film, and the positive electrode active material film. The positive electrode current collector film has a stacked structure of a titanium film and a titanium nitride film. The titanium film has a crystal structure belonging to a space group P6₃/mmc and a (101) orientation, the titanium nitride film has a crystal structure belonging to a space group Fm-3m and a (311) orientation, and the positive electrode active material film has a layered rock-salt crystal structure and a (116) orientation.

### BACKGROUND OF THE INVENTION

### 1. Field of the Invention

One embodiment of the present invention relates to an object or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of kinds of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Among the lithium-ion secondary batteries, an all-solid-state battery having higher safety has been developed. A thin-film secondary battery in which a positive electrode, an electrolyte, and/or a negative electrode are formed by physical vapor deposition (PVD), chemical vapor deposition (CVD), or the like is one kind of all-solid-state battery.

Patent Documents 1 and 2 each discloses a positive electrode including a thin film of lithium cobalt oxide.

### REFERENCE

[Patent Document 1] Japanese Published Patent Application No. 2009-295514
[Patent Document 2] Domestic re-publication of PCT international application No. 15-029289

### SUMMARY OF THE INVENTION

A crystal structure of lithium cobalt oxide is a layered rock-salt crystal structure that belongs to a space group R-3m where layers of lithium and layers formed of octahedrons of cobalt and oxygen are alternately stacked. It is known that lithium ions tend to move in the direction parallel to the layers (the direction parallel to the (003) plane of lithium cobalt oxide). For this reason, in the case where lithium cobalt oxide having crystallinity is used as a positive electrode active material, it is not preferred that the layers are parallel to a positive electrode and a negative electrode (that is to say, it is not preferred that lithium cobalt oxide has a (003) orientation). This is because the side for insertion and extraction of lithium ions does not face the negative electrode and it is difficult for lithium ions to be extracted from and inserted to the positive electrode accordingly. This leads to decreases in charge and discharge capacity and rate characteristics in the secondary battery.

On the other hand, it is known that a thin film of lithium cobalt oxide tends to easily have a (003) orientation. Patent Document 1 and Patent Document 2 employ a single crystal substrate having a particular plane orientation (e.g., STO substrate, Au substrate, or Pt substrate) in order to control the orientation of lithium cobalt oxide. However, the method using a single crystal substrate is not preferred because the single crystal substrate costs too much.

Thus, an object of one embodiment of the present invention is to provide a positive electrode active material film that does not have a (003) orientation and has a layered rock-salt crystal structure even though an inexpensive substrate such as a glass substrate is used. Another object of one embodiment of the present invention is to provide a positive electrode active material film with high productivity. Another object of one embodiment of the present invention is to provide a positive electrode active material film with high charge and discharge capacity. Another object of one embodiment of the present invention is to provide a positive electrode active material film with high rate characteristics.

Another object of one embodiment of the present invention is to provide a positive electrode that does not have a (003) orientation and has a layered rock-salt crystal structure even though an inexpensive substrate is used. Another object of one embodiment of the present invention is to provide a positive electrode with high productivity. Another object of one embodiment of the present invention is to provide a positive electrode with high charge and discharge capacity. Another object of one embodiment of the present invention is to provide a positive electrode with high rate characteristics.

Another object of one embodiment of the present invention is to provide a secondary battery or an electronic device with high productivity. Another object of one embodiment of the present invention is to provide a secondary battery or an electronic device with high safety or high reliability.

Another object of one embodiment of the present invention is to provide a novel substance, active material particles, or a power storage device or a manufacturing method thereof.

Note that the description of these objects does not preclude the existence of other objects. In one embodiment of the present invention, there is no need to achieve all the objects. Other objects can be derived from the description of the specification, the drawings, and the claims.

To achieve any of the above objects, in one embodiment of the present invention, a positive electrode current collector film provided between a substrate and a positive electrode active material film is given a function of controlling the orientation of the positive electrode active material film.

One embodiment of the present invention is a positive electrode formed over a first surface of a substrate. The positive electrode includes a positive electrode current collector film over the first surface of the substrate and a positive electrode active material film over the positive electrode current collector film. The positive electrode active material film has a layered rock-salt crystal structure belonging to a space group R-3m, and a (00l) plane of the positive electrode active material film is not parallel to the first surface of the substrate.

Another embodiment of the present invention is a positive electrode formed over a first surface of a substrate. The positive electrode includes a positive electrode current collector film over the first surface of the substrate and a positive electrode active material film over the positive electrode current collector film. The positive electrode active material film has a layered rock-salt crystal structure belonging to a space group R-3m, and an angle between a (00l) plane of the positive electrode active material film and the first surface of the substrate is greater than 5°.

In any of the above structures, in an out-of-plane X ray diffraction of the positive electrode active material film, a (116) plane is preferably observed in a range where an angle 2θ is greater than or equal to 77° and less than or equal to 81° and an angle ψ is greater than or equal to 0° and less than or equal to 5°.

Another embodiment of the present invention is a positive electrode formed over a first surface of a substrate. The positive electrode includes a positive electrode current collector film over the first surface of the substrate and a positive electrode active material film over the positive electrode current collector film. In a wide-angle reciprocal space map of the positive electrode active material film, at least a first spot and a second spot are observed, a peak of the first spot is in a range where an angle 2θ is greater than or equal to 17° and less than or equal to 21° and an angle ψ is greater than or equal to 45° and less than or equal to 70°, and a peak of the second spot is in a range where an angle 2θ is greater than or equal to 43° and less than or equal to 47° and an angle ψ is greater than or equal to 10° and less than or equal to 35°.

In any of the above structures, a crystal orientation of the positive electrode current collector film is preferably aligned with a crystal orientation of the positive electrode active material film.

In any of the above structures, the substrate is preferably a glass substrate or a resin substrate.

In any of the above structures, the positive electrode current collector film is preferably a stacked layer of two or more kinds of films.

In any of the above structures, the positive electrode current collector film is preferably a stacked layer of a titanium film and a titanium nitride film, and the titanium film, the titanium nitride film, and the positive electrode active material film are preferably formed in this order over the substrate.

In any of the above structures, preferably, the titanium film has a crystal structure belonging to a space group P6₃/mmc and a (101) orientation, the titanium nitride film has a crystal structure belonging to a space group Fm-3m and a (311) orientation, and the positive electrode active material film has a (116) orientation.

In any of the above structures, the positive electrode active material film preferably includes at least one of cobalt, nickel, and manganese.

Another embodiment of the present invention is a secondary battery including the above-described positive electrode, a solid electrolyte, and a negative electrode.

Another embodiment of the present invention is an electronic device including the above-described secondary battery, an antenna, and a charge and discharge circuit.

According to one embodiment of the present invention, a positive electrode active material film that does not have a (003) orientation and has a layered rock-salt crystal structure even with use of an inexpensive substrate can be provided. According to another embodiment of the present invention, a positive electrode active material film with high productivity can be provided. According to another embodiment of the present invention, a positive electrode active material film with high charge and discharge capacity can be provided. According to another embodiment of the present invention, a positive electrode active material film with high rate characteristics can be provided.

According to one embodiment of the present invention, a positive electrode that does not have a (003) orientation and has a layered rock-salt crystal structure even with use of an inexpensive substrate can be provided. According to another embodiment of the present invention, a positive electrode with high productivity can be provided. According to another embodiment of the present invention, a positive electrode with high charge and discharge capacity can be provided. According to another embodiment of the present invention, a positive electrode with high rate characteristics can be provided.

Alternatively, a secondary battery or an electronic device with high productivity can be provided. Furthermore, a highly safe or reliable secondary battery or electronic device can be provided.

One embodiment of the present invention can provide a novel material, active material particles, a power storage device, or a manufacturing method thereof.

Note that the description of these effects does not preclude the existence of other effects. One embodiment of the present invention does not necessarily have all the effects. Other effects will be apparent from and can be derived from the descriptions of the specification, the drawings, the claims, and the like.

### BRIEF DESCRIPTION OF THE DRAWINGS

In the accompanying drawings:

FIGS. 1A and 1B each illustrate an example of a secondary battery;

FIG. 2 is an experimental layout in wide-angle reciprocal space mapping;

FIGS. 3A and 3B each illustrate an example of a secondary battery;

FIG. 4A is a top view of an example of a secondary battery and FIGS. 4B and 4C are each a cross-sectional view illustrating an example of the secondary battery;

FIG. 5A is a top view illustrating an example of a secondary battery and FIG. 5B is a cross-sectional view illustrating the example of the secondary battery;

FIG. 6 is a flow chart illustrating an example of a method for manufacturing a secondary battery;

FIG. 7A and FIGS. 7B and 7C each illustrate an example of an electronic device; FIG. 8 illustrates an electronic device;

FIGS. 9A to 9C each illustrate an example of an electronic device;

FIGS. 10A and 10B show XRD patterns in Example;

FIGS. 11A and 11B show XRD patterns in Example;

FIG. 12 show an XRD pattern in Example;

FIGS. 13A and 13B show wide-angle reciprocal space maps in Example;

FIGS. 14A and 14B show wide-angle reciprocal space maps in Example; and

FIG. 15 is a charge-discharge curve of a secondary battery in Example.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

In this specification and the like, ordinal numbers such as “first”, “second”, and “third” are used in order to avoid confusion among components. Thus, the terms do not limit the number of components. The terms do not limit the order of components, either. In this specification and the like, for example, a “first” component in one embodiment can be referred to as a “second” component in other embodiments or claims. For another example, a “first” component in one embodiment in this specification and the like can be omitted in other embodiments or claims.

The same elements or elements having similar functions, elements formed using the same material, elements formed at the same time, or the like in the drawings are denoted by the same reference numerals, and the description thereof is not repeated in some cases. The same elements, elements having similar functions, elements formed of the same material, elements formed at the same time, and the like are represented by the same hatch pattern and the reference numerals for such elements are omitted in some cases.

A secondary battery includes a positive electrode and a negative electrode, for example. A positive electrode active material is a material included in the positive electrode. The positive electrode active material is a substance that performs a reaction contributing to the charge and discharge capacity, for example. Note that the positive electrode active material may partly contain a substance that does not contribute to the charge and discharge capacity.

Moreover, the positive electrode active material of one embodiment of the present invention is expressed as a positive electrode material, a secondary battery positive electrode material, a composite oxide, or the like in some cases. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

Charging of a positive electrode active material refers to extraction of conductive ions. Charging of a negative electrode active material refers to insertion of conductive ions. Discharging of a positive electrode active material refers to insertion of conductive ions. Discharging of a negative electrode active material refers to extraction of conductive ions. A case where conductive ions are lithium ions is described below.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, crystal planes, crystal orientations, and space groups are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and, in some cases, not only (hkl) but also (hkil) is used as the Miller index. Note that i in (hkil) is −(h+k). In this specification and the like, a crystal plane or the like in the space group R-3m is represented with use of a composite hexagonal lattice, unless otherwise specified.

In addition, a given integer of 1 or more is represented by h, k, i, or l in some cases. Examples of (00l) include (001), (003), and (006).

The space group of a crystal structure is identified by XRD, electron diffraction, neutron diffraction, or the like. Thus, in this specification and the like, belonging to a space group or being a space group can be rephrased as being identified as a space group.

In this specification and the like, a layered rock-salt crystal structure of a composite oxide containing lithium and a transition metal refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which cations and anions are alternately arranged. Note that a cation or anion vacancy may exist.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned right above voids between anions packed in a first layer, and anions in a third layer are placed at the positions that are positioned right above voids between the anions in the second layer and are not positioned right above the anions in the first layer. Accordingly, it is acceptable that anions do not exactly form a cubic lattice structure. Moreover, actual crystals often have a defect and thus, analysis results are not necessarily consistent with the theory. For example, in an electron diffraction pattern or a fast Fourier transform (FFT) pattern of a TEM image or the like, a spot may appear in a position slightly different from a theoretical position. For example, anions may be regarded as forming a cubic close-packed structure when a difference in orientation from a theoretical position is greater than or equal to 0° and less than or equal to 5° or greater than or equal to 0° and less than or equal to 2.5°.

The (hkl) orientation indicates that a crystal plane parallel to a substrate is an (hkl) plane. Specifically, in an observation of a film with XRD or the like, when a plane that is observed most clearly as a plane parallel to a substrate is an (hkl) plane, the film has an (hkl) orientation. Therefore, the (hkl) plane is not necessarily parallel to a substrate in the entire film and another crystal plane may be parallel to the substrate in part of the film. The term “parallel” in this specification and the like means a state that the angle with respect to the surface of a substrate is greater than or equal to 0° and less than or equal to 5°, preferably greater than or equal to 0° and less than or equal to 2.5°. Similarly, the term “not parallel” means a state that the angle with respect to the surface of a substrate is greater than 5°.

In this specification and the like, an example in which a lithium metal is used for a counter electrode in a secondary battery including a positive electrode and a positive electrode active material of one embodiment of the present invention is described in some cases; however, the secondary battery of one embodiment of the present invention is not limited to this example. A different material such as graphite or lithium titanate may be used for a negative electrode, for example. The properties of the positive electrode and the positive electrode active material film of one embodiment of the present invention, such as a crystal structure unlikely to be broken by repeated charge and discharge and excellent cycle performance, are not affected by the material of the negative electrode.

### Embodiment 1

### «Positive Electrode»

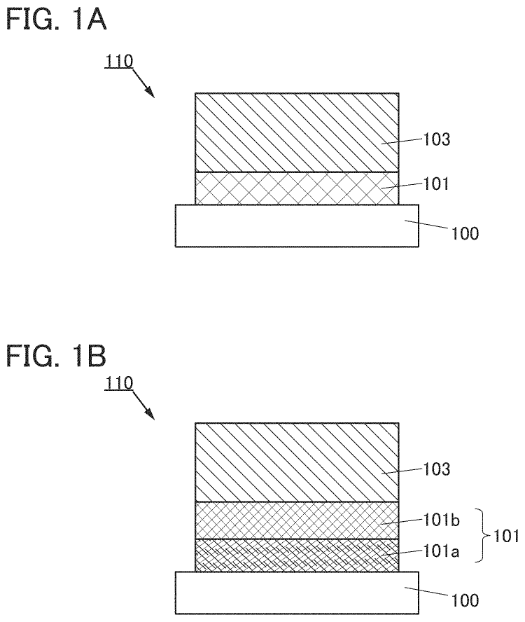

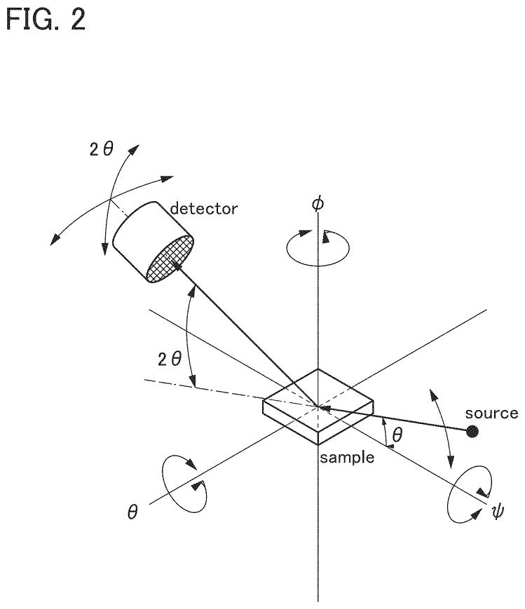

First, a positive electrode 110 and a positive electrode active material film 103 of one embodiment of the present invention are described with reference to FIGS. 1A and 1B and FIG. 2.

The positive electrode 110 of one embodiment of the present invention includes a positive electrode current collector film 101 and the positive electrode active material film 103 over a substrate 100 in this order.

### <Substrate>

Examples of a substrate that can be used as the substrate 100 include a glass substrate, a resin substrate, a ceramic substrate, a silicon substrate, and a metal substrate. The substrate 100 may have a crystallinity. For example, the substrate may be single crystal or polycrystal. However, it is preferable to use an amorphous substrate including a glass substrate as the substrate 100. This is because an amorphous substrate is inexpensive and offers high productivity, as compared with a single crystal substrate.

A flexible glass substrate, a flexible resin substrate, or the like is further preferably used, in which case the flexible positive electrode 110 can be provided.

The substrate 100 preferably has heat resistance because it goes through a later step including heating (e.g., 300° C. or higher). Thus, when a resin substrate is used, a high heat-resistant material such as polyimide is preferably used, for example.

### <Positive Electrode Current Collector Film>

As a material of the positive electrode current collector film 101, one or more conductive material selected from titanium, aluminum, copper, gold, chromium, tungsten, molybdenum, nickel, silver, and nitride or oxide thereof are used, for example. Titanium nitride especially is preferred because titanium nitride has a rock-salt crystal structure in which titanium cations and nitrogen anions are alternately arranged and has a sufficient conductivity.

As the positive electrode current collector film 101, a plurality of materials are preferably stacked. For example, as illustrated in FIG. 1B, a positive electrode current collector film 101a and a positive electrode current collector film 101b are preferably stacked. Such a structure can strengthen the effect of controlling the orientation of the positive electrode active material film 103, described later, and increase the conductivity.

In a preferred example, titanium is used as the positive electrode current collector film 101a and titanium nitride is used as the positive electrode current collector film 101b. When the positive electrode current collector film 101a and the positive electrode current collector film 101b have a metal element in common as in the example, continuous deposition using the same target in sputtering is possible, which is preferable also in terms of high productivity.

Furthermore, when titanium nitride is used as the positive electrode current collector film 101b, the thickness of the positive electrode current collector film 101b is preferably greater than 40 nm, further preferably greater than or equal to 100 nm, still further preferably greater than or equal to 200 nm. In contrast, because a too large thickness might decrease the productivity, the thickness is preferably 1000 nm or less.

The use of the positive electrode current collector film 101b with a thickness in the above range can have a sufficient effect of controlling the orientation of the positive electrode active material film 103.

<Positive Electrode Active Material Film>

The positive electrode active material film 103 contains lithium, a transition metal M, and oxygen. In other words, the positive electrode active material film 103 includes composite oxide containing lithium and a transition metal M.

As the transition metal M contained in the positive electrode active material film 103, a metal that can form, together with lithium, a layered rock-salt composite oxide belonging to the space group R-3m is preferably used. For example, one or more of manganese, cobalt, and nickel can be used as the transition metal M. That is, as the transition metal M contained in the positive electrode active material film 103, cobalt or nickel alone may be used, two elements, cobalt and manganese or cobalt and nickel may be used, or three elements, cobalt, manganese, and nickel may be used. In other words, the positive electrode active material film 103 can contain a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

In addition to the above, the positive electrode active material film 103 may contain an element other than the transition metal M, such as magnesium, fluorine, aluminum, calcium, or zirconium. Such elements further stabilize the crystal structure of the positive electrode active material film 103 in some cases. In other words, the positive electrode active material film 103 can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-magnesium-aluminum oxide, or the like.

### <Crystallinity and Orientation of Positive Electrode Current Collector Film and Positive Electrode Active Material Film>

The positive electrode current collector film 101 preferably has a function of controlling the orientation of the positive electrode active material film 103.

Thus, the positive electrode current collector film 101 preferably has crystallinity. In particular, in the positive electrode current collector film 101, a region that is close to the interface with the positive electrode active material film 103 preferably has crystallinity. The positive electrode current collector film 101 preferably has a crystal structure that is similar to the crystal structure of the positive electrode active material film 103. For example, in the case where the positive electrode active material film 103 is a composite oxide having a layered rock-salt crystal structure, the positive electrode current collector film 101 preferably has a layered rock-salt or a rock-salt crystal structure. The layered rock-salt crystal structure and the rock-salt crystal structure are common in that cations and anions are alternately arranged, and thus can be similar crystal structures.

In the case where the positive electrode current collector film 101 in which a plurality of materials are stacked is used, preferably, at least a material that is in contact with the interface with the positive electrode active material film 103 has crystallinity and further has a crystal structure similar to the positive electrode active material film 103. For example, in the case where the crystal structure of the positive electrode active material film 103 in FIG. 1B is a layered rock-salt crystal structure, at least the positive electrode current collector film 101b preferably has a layered rock-salt crystal structure or a rock-salt crystal structure. The positive electrode current collector film 101 preferably has a region with a structure similar to the positive electrode active material film 103 from the interface with the positive electrode active material film 103, and the thickness of the region is preferably larger than 40 nm, further preferably 100 nm or larger, still further preferably 200 nm or larger and preferably 1000 nm or less, further preferably 700 nm or less, still further preferably 500 nm or less. A too small thickness of the region might decrease the effect of sufficiently controlling the orientation, whereas a too large thickness of the region might decrease the productivity.

The orientation of a crystal included in the positive electrode current collector film 101 is preferably aligned with the orientation of a crystal included in the positive electrode active material film 103. In the case where the crystal orientations are aligned, a function of the positive electrode current collector film 101 as a base film controlling the orientation is considered to be sufficiently exhibited.

The alignment in the crystal orientations is described below. Anions of a layered rock-salt crystal and anions of a rock-salt crystal form a cubic close-packed structure (face-centered cubic lattice structure). Thus, when a layered rock-salt crystal and a rock-salt crystal are in contact with each other, there is a crystal plane at which orientations of cubic close-packed structures formed of anions are aligned with each other.

This can also be described as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the {0001} plane of the layered rock-salt crystal structure has a hexagonal lattice. The triangle lattice on the {111} plane of the cubic crystal has atomic arrangement similar to that of the hexagonal lattice on the {0001} plane of the layered rock-salt crystal structure. These lattices being consistent with each other can be expressed as “orientations of the cubic close-packed structures are aligned with each other”.

Note that a space group of the layered rock-salt crystal is R-3m, which is different from a space group Fm-3m of a rock-salt crystal (the space group of a general rock-salt crystal); thus, the Miller index of the crystal plane satisfying the above conditions in the layered rock-salt crystal is different from that in the rock-salt crystal.

In this specification, in the layered rock-salt crystal and the rock-salt crystal, a state where the orientations of the cubic close-packed structures formed of anions are aligned with each other may be referred to as a state where crystal orientations are substantially aligned with each other. Note that “the crystal orientations are aligned with each other in a thin film sample” includes a case where the orientations of the cubic close-packed structures are at any angle in a substrate plane.

As described above, it is not preferable that the layered rock-salt type positive electrode active material film 103 have a (003) orientation, in which case extraction and insertion of lithium ions from/into the positive electrode active material become difficult. When the rock-salt type positive electrode current collector film 101 has a (111) orientation, the layered rock-salt type positive electrode active material film 103 can easily have a (003) orientation. This is because the combination of the (111) plane of the rock-salt crystal structure and the (003) plane of the layered rock-salt crystal structure facilitates the orientation alignment. Therefore, the positive electrode current collector film 101 without (111) orientation is preferred in the case of the rock-salt crystal structure.

In the positive electrode current collector film 101 having a stack of different materials, when the material in contact with the interface with the positive electrode active material film 103 has the rock-salt crystal structure, preferably, the material does not have a (111) orientation. For example, in the case of the structure in FIG. 1B, the positive electrode current collector film 101b without (111) orientation is preferred in the case of rock-salt crystal structure.

A material, e.g., the positive electrode current collector film 101a, between the positive electrode current collector film 101b and the substrate 100 preferably has a function of controlling the orientation of the positive electrode current collector film 101b. For example, when the positive electrode current collector film 101b has a rock-salt crystal structure, the material preferably has a function of allowing the positive electrode current collector film 101b not to have a (111) orientation.

In addition, the function of controlling the orientation is sufficiently exhibited and accordingly, the crystal orientations of the positive electrode current collector film 101a and the positive electrode current collector film 101b are preferably aligned with each other. Thus, the positive electrode current collector film 101a and the positive electrode current collector film 101b preferably have crystallinity.

Titanium is preferred because the conductivity of titanium is higher than those of titanium nitrides and titanium oxides. In addition, titanium nitride is preferred because titanium nitride has a function of a base film sufficiently controlling the orientation of the positive electrode active material film 103. The positive electrode current collector film 101 having a stacked structure in which titanium is used as the positive electrode current collector film 101a and titanium nitride is used as the positive electrode current collector film 101b is preferable because both the high conductivity and the function of controlling the orientation of the positive electrode active material film 103 can be offered.

Note that the positive electrode of one embodiment of the present invention is not limited to the structures in FIGS. 1A and 1B. As long as the positive electrode active material film 103 having a layered rock-salt crystal structure does not have a (003) orientation, any other material, crystal structure, and orientation may be used. For example, lithium cobalt oxide having a (104) orientation may be placed over strontium titanium oxide having a (100) orientation. Alternatively, lithium cobalt oxide having a (110) orientation may be placed over strontium titanium oxide having a (110) orientation.

Note that the interface between different materials, for example, the interface between the positive electrode current collector film 101a and the positive electrode current collector film 101b, the interface between the positive electrode current collector film 101b and the positive electrode active material film 103, and the like, is not clear in some cases. For example, a mixed region of elements of the both may exist near the interface. In the mixed region, at least one of the elements may have a concentration gradient. Thus, the crystal structure of the mixed region may vary continuously and may have features of the both in some cases.

For example, when the positive electrode current collector film 101b is titanium nitride and the positive electrode active material film 103 is lithium cobalt oxide, a region including titanium oxynitride (TiOₓN_{y}, 0<x<2, 0<y<1), a region including lithium cobalt titanate (LiCo_{z}Ti_{(1-z)}O₂, 0<z<1), or the like may exist in the vicinity of the interface between the positive electrode current collector film 101b and the positive electrode active material film 103. At least one of titanium, cobalt, oxygen, nitrogen, and lithium in the vicinity of the interface may have a concentration gradient.

### <Analysis>

Note that the compositions, interface, crystallinity, orientations, and the like of the positive electrode current collector film 101a, the positive electrode current collector film 101b, the positive electrode active material film 103, and the like can be evaluated by various analysis methods described below as examples.

When an element included in a film has a concentration gradient, the local composition of a material and the local concentration gradient of the element can be evaluated with use of energy dispersive X-ray spectroscopy (EDX), electron probe microanalysis (EPMA), secondary ion mass spectrometry (SIMS), or the like.

The concentration evaluation of each element in a wider range, as in the positive electrode 110 and the like, can be performed with use of inductively coupled plasma mass spectrometry (ICP-MS), glow discharge mass spectrometry (GD-MS), or the like.

In an analysis by EDX or the like, a measurement point at which the transition metal M such as cobalt shows the measurement value closet to 50% of the average value of the detected values in the positive electrode active film 103 can be regarded as the interface between the positive electrode active material film 103 and the positive electrode current collector film 101. Alternatively, the interface can be an intersecting point between a tangent drawn by a tangent method to an intensity profile of the transition metal M obtained by EDX line analysis and an axis in the depth direction.

The orientations of crystals in two regions being aligned with each other can be determined, for example, from a transmission electron microscope (TEM) image, a scanning transmission electron microscope (STEM) image, a high-angle annular dark field scanning TEM (HAADF-STEM) image, an annular bright-field scanning transmission electron microscope (ABF-STEM) image, an enhanced hollow-cone illumination-TEM (eHCI-TEM) image, an electron diffraction pattern or an FFT pattern obtained from any of the images, for example.

In addition, analysis methods such as reciprocal space mapping, wide-angle reciprocal space mapping (WRSM), pole figure measurement, phi-scan analysis, out-of-plane measurement, in-plane measurement, and rocking curve measurement of X-ray diffraction (XRD) can be combined to determine the alignment of the crystal orientations. Furthermore, a neutron diffraction pattern or the like can be employed to determine the alignment of the crystal orientations.

In a TEM image, a STEM image, a HAADF-STEM image, an ABF-STEM image, and the like, an image reflecting a crystal structure is obtained. For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines is greater than or equal to 0° and less than or equal to 5° or greater than or equal to 0° and less than or equal to 2.5° in the TEM image, it can be determined that the crystal planes are aligned with each other, that is, orientations of the crystals are aligned with each other. Similarly, when the angle between the dark lines is greater than or equal to 0° and less than or equal to 5° or greater than or equal to 0° and less than or equal to 2.5°, it can be determined that orientations of the crystals are aligned with each other. In general, it is difficult to clearly differentiate “perfectly aligned” from “substantially aligned”. In this specification, the expression “aligned” includes both “perfectly aligned” (where the angle between bright lines is 0°, for example) and “substantially aligned”.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis.

Consequently, in the case where repetition of bright lines and dark lines is observed in two regions having different crystal structures and the angle between the bright lines is greater than or equal to 0° and less than or equal to 5° or greater than or equal to 0° and less than or equal to 2.5° in a HAADF-STEM image, it can be determined that arrangements of the atoms are aligned with each other, that is, orientations of the crystals are aligned with each other. Similarly, when the angle between the dark lines is greater than or equal to 0° and less than or equal to 5° or greater than or equal to 0° and less than or equal to 2.5°, it can be determined that orientations of the crystals are aligned with each other.

With an ABF-STEM, an element having a smaller atomic number is observed to be brighter, but a contrast corresponding to the atomic number is obtained, as with a HAADF-STEM; hence, in an ABF-STEM image, crystal orientations can be determined as in a HAADF-STEM image.

When the orientations of the layered rock-salt crystal and the rock-salt crystal are aligned with each other in the above manner in FFT and electron diffraction, the <0003> orientation of the layered rock-salt crystal and the <11-1> orientation of the rock-salt crystal are aligned with each other in some cases. In that case, it is preferred that these reciprocal lattice points be spot-shaped, that is, they be not connected to other reciprocal lattice points. The state where reciprocal lattice points are spot-shaped and not connected to other reciprocal lattice points means high crystallinity.

To determine alignment of crystal orientations in a TEM image or the like, a sample is preferably processed to be thin so that the (0003) plane of the layered rock-salt crystal structure is easily observed. For example, a sample to be observed is preferably processed to be thin using a focused ion beam (FIB) or the like such that an electron beam of a TEM, for example, enters in [12-10].

Thin film XRD, which is one method of XRD, can precisely evaluate the crystal orientation of a thin film more accurately by appropriately combining any of a variety of measurement methods and measurement equipment such as out-of-plane measurement, in-plane measurement, pole figure measurement, phi scan, grazing incidence X-ray diffraction (GIXRD), reciprocal space mapping, wide-angle reciprocal space mapping, a 0-dimensional detector (also referred to scintillation counter), a 1-dimensional detector, and a 2-dimensional detector.

Wide-angle reciprocal space mapping is described below. A reciprocal space is a space that is composed of a basic vector of a reciprocal space (also referred to as a reciprocal vector) and reflects the periodicity of the real space. Here, a reciprocal vector bⱼ and a basic vector aᵢ of the real space have a relationship shown in the following formula (1). That is, a plane defined in a crystal of the real space is regarded as a lattice point in a reciprocal lattice.

[Equation 1]

aᵢ·bⱼ=2πδ_{i,j} (1)

Thus, when a reciprocal space map of a thin film with aligned crystal orientations is obtained, the intensity of an observed spot is high, and a half-width of the spot is small. In contrast, when a reciprocal space map of a thin film with a large variation in the crystal orientation, i.e., low orientation, of the crystals, is obtained, the intensity of an observed spot is low and the half-width of the spot is large. In this manner, the reciprocal space map is obtained, whereby the crystallinity and orientation of the thin film can be evaluated.

Wide-angle reciprocal space mapping using an X-ray analysis apparatus is described with reference to FIG. 2. Here, as illustrated in FIG. 2, a direction in which an X-ray source (source), a sample, and a detector are arranged in line when the X-ray analysis apparatus is seen from the above is referred to as a ψ (psi) axis. A direction perpendicular to the ψ axis when the X-ray analysis apparatus is seen from the above is referred to as a θ axis. A direction perpendicular to the ψ axis and the θ axis is referred to as a ϕ (phi) axis. That is, the ϕ axis is parallel to the direction in which the X-ray analysis apparatus is seen from the above. Note that an axis that is referred to as the ψ axis in this specification may be referred to as a χ axis depending on an apparatus. Therefore, the ψ axis can also be referred to as a χ axis. Similarly, an axis that is referred to as the θ axis in this specification may be referred to as a co axis depending on an apparatus. Thus, the θ axis can also be referred to as a co axis.

A two-dimensional detector is used as the detector in the wide-angle reciprocal space mapping in some cases. The two-dimensional detector has positional information of 2θ and the ψ direction with respect to the detection surface. Note that the detector illustrated in FIG. 2 is modeled on a two-dimensional detector.

As illustrated in FIG. 2, the wide-angle reciprocal space mapping is performed by moving the sample and the detector when the X-ray source is fixed. Here, the detector can be tilted in a 2θ direction, and the sample can tilted in the θ direction, the ϕ direction, and the ψ direction. The wide-angle reciprocal space mapping is a measurement method in which a 2θ/θ scan is executed in each ψ position (angle) while the sample is tilted in the ψ direction in stages. Accordingly, a wide-angle reciprocal space map for a wide measurement area in the reciprocal space can be obtained. In the case where the X-ray source is a movable type, wide-angle reciprocal space mapping is performed by moving the X-ray source, the sample, and the detector. Here, the X-ray source can be tilted in the θ direction. Note that unless otherwise specified, a value obtained with a CuKα ray (wavelength: 0.15418 nm) used as the X-ray source is used in this specification. In addition, ψ is greater than or equal to 0° unless otherwise specified.

To analyze intensity distribution that appears in the obtained wide-angle reciprocal space map, calculation of a wide-angle reciprocal space map is performed. For the calculation of a wide-angle reciprocal space map, software provided by Bruker Japan K.K., “SMAP/for Cross Sectional XRD-RSM”, can be used, for example. Parameters of a crystal structure, lattice constant, and orientation are input into the software, whereby the calculation result of a wide-angle reciprocal space map corresponding to the input values is output. The intensity distribution appearing in the wide-angle reciprocal space map obtained by the measurement can be analyzed by comparison of the wide-angle reciprocal space map output in the calculation with the wide-angle reciprocal space map obtained by the measurement.

A peak of a spot that appears in a reciprocal space map indicates a portion with the highest intensity in the spot obtained as a result of the above intensity distribution analysis.

### «Secondary Battery»

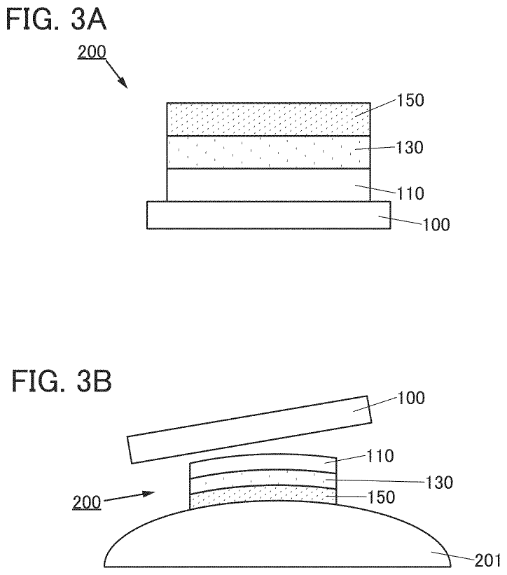

A secondary battery 200 of one embodiment of the present invention is described with reference to FIGS. 3A and 3B.

As illustrated in FIG. 3A, the secondary battery 200 includes the above-described positive electrode 110, a solid electrolyte 130, and a negative electrode 150 over the substrate 100.

Examples of materials usable for the solid electrolyte 130 include Li_{0.35}La_{0.55}TiO₃, La_{(2/3-a)}Li₃ₐTiO₃, Li₃PO₄, LiₐPO_{(4-b)}N_{b}, LiNb_{(1-z)}Ta₍ₐ₎WO₆, Li₇La₃Zr₂O₁₂, Li₍₁₊ₐ₎Al₍ₐ₎Ti₍₂₋ₐ₎(PO₄)₃, Li₍₁₊ₐ₎Al₍ₐ₎Ge₍₂₋ₐ₎(PO₄)₃, and LiNbO₂. Note that a>0 and b>1. As a deposition method, a sputtering method, an evaporation method, or the like can be used.

In addition, SiO_{c} (0<c≤2) can also be used for the solid electrolyte 130. SiO_{c} (0<c≤2) may be used for the solid electrolyte 130, and SiO_{c} (0<c≤2) may also be used for the negative electrode 150. In this case, the ratio of oxygen to silicon (O/Si) in SiO_{c} is preferably higher in the solid electrolyte 130 than in that of the negative electrode 150. With this structure, conductive ions (particularly lithium ions) in the solid electrolyte 130 are likely to diffuse, and conductive ions (particularly lithium ions) in the negative electrode 150 are likely to be extracted or accumulated, whereby a solid-state secondary battery with favorable characteristics can be obtained. When the solid electrolyte 130 and the negative electrode 150 are formed using materials containing the same components as described above, a secondary battery can be manufactured easily.

Further alternatively, the solid electrolyte 130 may have a stacked-layer structure. In the case of a stacked-layer structure, a material in which nitrogen is added to lithium phosphate (Li₃PO₄) (the material is also referred to as Li₃PO_{(4-Z)}N_{Z} (Z>0), also referred to as LiPON) may be stacked as one layer of the stacked layers.

The negative electrode 150 may be formed using one material as illustrated in FIG. 3A or may have a stacked structure of a negative electrode active material film and a negative electrode current collector film although not illustrated.

The negative electrode 150 is formed using one material, in which case the secondary battery 200 can be formed thinner in a simpler process than in the case of the stacked structure. In the case where the negative electrode 150 is formed using one material, examples of materials usable for the negative electrode 150 include lithium, lithium-aluminum alloy, lithium-silicon alloy, lithium-tin alloy, and lithium-gallium alloy.

In the case where the negative electrode 150 has a stacked structure of a negative electrode active material film and a negative electrode current collector film, examples of materials usable for the negative electrode active material include silicon, SiO_{c} (0<c≤2), carbon, titanium oxide, vanadium oxide, indium oxide, zinc oxide, tin oxide, and nickel oxide. A lithium titanium oxide (Li₄Ti₅O₁₂, LiTi₂O₄, or the like) may also be used. Moreover, lithium, lithium-aluminum alloy, lithium-silicon alloy, lithium-tin alloy, lithium-gallium alloy, or the like may be used.

As a material of the negative electrode current collector film, one or more kinds of conductive materials selected from Al, Ti, Cu, Au, Cr, W, Mo, Ni, Ag, and the like can be used.

Furthermore, a protective layer is preferably provided over the secondary battery 200.

After the secondary battery 200 is formed over the substrate 100 as illustrated in FIG. 3B, the secondary battery 200 may be transferred to another substrate 201. Through the steps, the secondary battery 200 can be formed, irrespective of heat resistance of the substrate 201.

For analysis of the compositions, structures, and the like of the solid electrolyte 130, the negative electrode 150, and the like, the analysis method of the positive electrode can be referred to.

Although the secondary battery in which not only the positive electrode 110 but also the solid electrolyte 130 and the negative electrode 150 are formed of thin films is described in FIGS. 3A and 3B, one embodiment of the present invention is not limited to the secondary battery. One embodiment of the present invention may be a secondary battery including an electrolytic solution. Alternatively, one embodiment of the present invention may be a secondary battery including an electrolytic solution and a negative electrode serving as both a negative electrode current collector film and a negative electrode active material film. Moreover, one embodiment of the present invention may be a secondary battery including a negative electrode formed by applying powder of a negative electrode active material to a negative electrode current collector.

This embodiment can be implemented in combination with any of the other embodiments.

### Embodiment 2

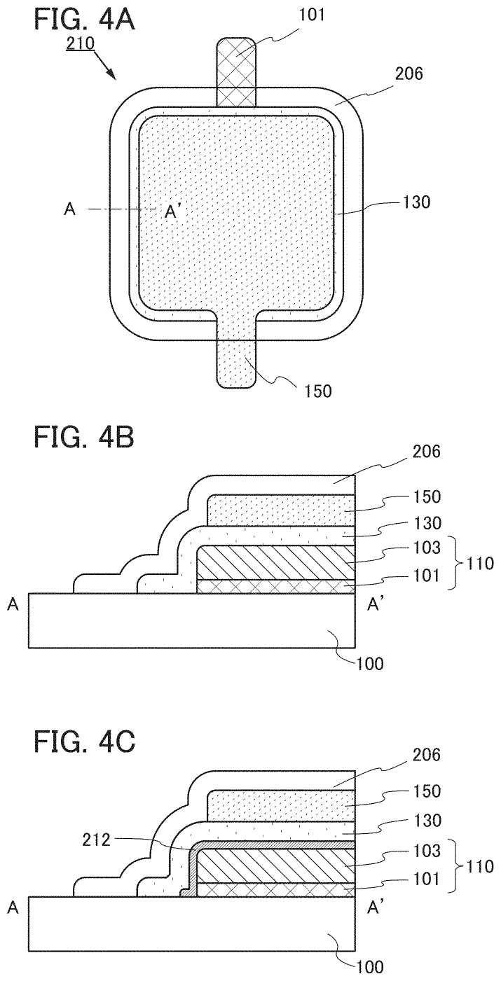

In this embodiment, examples of a specific shape of a secondary battery of one embodiment of the present invention and an example of a manufacturing method thereof will be described with reference to FIGS. 4A to 4C, FIGS. 5A and 5B, and FIG. 6.

### [Structure of Secondary Battery]

FIG. 4A is a top view of a secondary battery and FIG. 4B is a cross-sectional view taken along the dashed-and-dotted line A-A′ in FIG. 4A. A secondary battery 210 is a thin-film battery, in which the positive electrode 110 described in the foregoing embodiment is formed over the substrate 100, the solid electrolyte 130 is formed over the positive electrode 110, and the negative electrode 150 is formed over the solid electrolyte 130 as illustrated in FIG. 4B. The negative electrode 150 may have a stacked structure of a negative electrode active material film and a negative electrode current collector film.

In the secondary battery 220, the protective layer 206 is preferably formed over the positive electrode 110, the solid electrolyte 130, and the negative electrode 150.

As illustrated in FIG. 4A, exposed parts of the negative electrode 150 and the positive electrode collector film 101 serve a negative electrode terminal portion and a positive electrode terminal portion, respectively. A region other than the negative electrode terminal portion and the positive electrode terminal portion is covered with the protective layer 206.

The secondary battery 210 may include a cap layer 212 over the positive electrode 110 as illustrated in the cross-sectional view in FIG. 4C. The cap layer 212 has a function of suppressing a side reaction between the positive electrode active material film 103 and the solid electrolyte 130.

For the cap layer 212, titanium or a titanium compound is preferably used. As the titanium compound, it is preferable to use titanium oxide, titanium nitride, titanium oxide in which nitrogen is substituted for part of oxygen, titanium nitride in which oxygen is substituted for part of nitrogen, or titanium oxynitride (TiOₓN_{y}, where 0<x<2 and 0<y<1), for example. Titanium is a material that can be contained in a solid electrolyte. Therefore, titanium and a titanium compound are particularly preferable for the cap layer 212.

Although the secondary battery in which not only the positive electrode but also the solid electrolyte and the negative electrode are formed of thin films is described in FIGS. 4A to 4C, one embodiment of the present invention is not limited to the structure. One embodiment of the present invention may be a secondary battery including an electrolytic solution. Another embodiment of the present invention may be a secondary battery including an electrolytic solution and a negative electrode serving as both a negative electrode current collector film and a negative electrode active material film. Another embodiment of the present invention may be a secondary battery including a negative electrode formed by applying powder of a negative electrode active material to a negative electrode current collector.

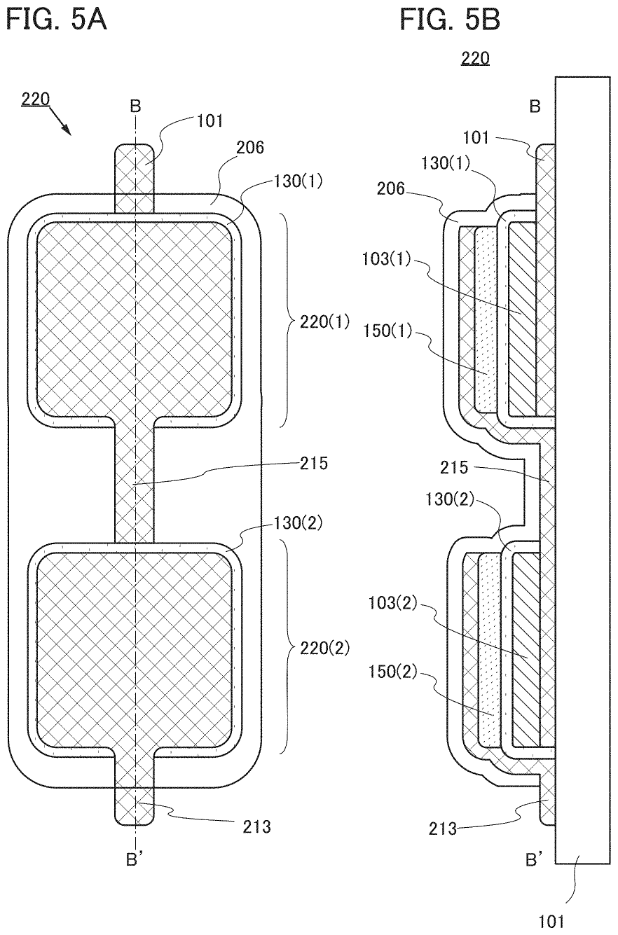

A plurality of cells may be connected in series or in parallel in a secondary battery. A secondary battery 220 illustrated in FIGS. 5A and 5B is a thin-film battery having a cell 220(1) and a cell 220(2) that are connected in series. FIG. 5A is a top view, and FIG. 5B is a cross-sectional view taken along the dashed-and-dotted line B-B′ of FIG. 5A.

The cell 220(1) includes the positive electrode current collector film 101, a positive electrode active material film 103(1), a solid electrolyte 130(1), a negative electrode 150(1), and a current collector film 215. The cell 220(2) includes the current collector film 215, a positive electrode active material film 103(2), a solid electrolyte 130(2), a negative electrode 150(2), and a negative electrode current collector film 213. The negative electrode of the cell 220(1) and the positive electrode of the cell 220(2) are electrically connected to each other by the current collector film 215. The positive electrode current collector film 101 serves as a positive electrode current collector film of the cell 220(1) and the current collector film 215 serves as a positive electrode current collector film of the cell 220(2). Thus, the positive electrode current collector film 101 and the current collector film 215 preferably have the same structure and include the same materials as those of the positive electrode current collector film 101 described in the above embodiment.

Although the thin-film battery including two cells is described with reference to FIGS. 5A and 5B, one embodiment of the present invention is not limited thereto. The thin-film battery may be a thin-film battery including three or more cells.

### [Manufacturing Method]

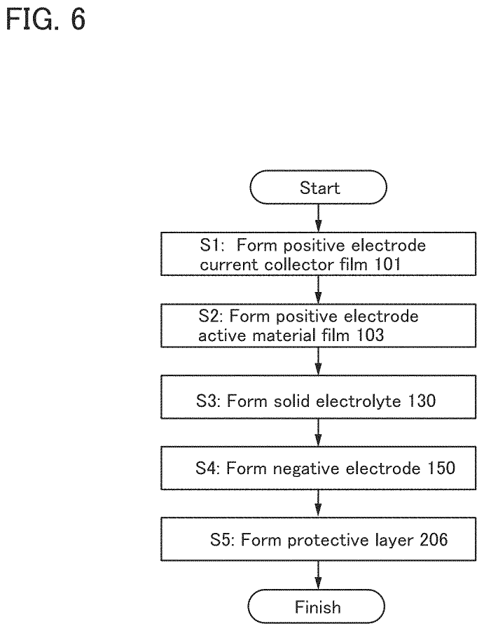

Next, an example of a procedure of a method for manufacturing the secondary battery 210 illustrated in FIGS. 4A and 4B will be described with reference to a flow chart of FIG. 6.

First, the positive electrode current collector film 101 is formed over the substrate 100 (S1). As a deposition method for the positive electrode current collector film 101, an evaporation method, or the like as well as a sputtering method can be used. In a sputtering method, using a metal mask enables a film to be deposited in a selected area. In addition, the positive electrode current collector film 101 may be patterned by being selectively removed by dry etching or wet etching using a resist mask or the like.

For example, in the case where titanium nitride is used for the positive electrode current collector film 101, titanium nitride can be deposited by a reactive sputtering method using a titanium target and a nitrogen gas.

In the case where the positive electrode current collector film 101 is formed by stacking a plurality of materials, the stacked layers of the materials are preferably formed successively. For example, when titanium is used as the positive electrode current collector film 101a and titanium nitride is used as the positive electrode current collector film 101b, the titanium and the titanium nitride are preferably deposited successively using the same target.

Next, the positive electrode active material film 103 is deposited (S2). The positive electrode active material film 103 can be formed by a sputtering method using a sputtering target that includes, as its main component, an oxide containing lithium and the transition metal M that is one or more of manganese, cobalt, and nickel, for example. It is possible to use, for example, a sputtering target including lithium cobalt oxide (LiCoO₂, LiCo₂O₄, or the like) as its main component, a sputtering target including a lithium manganese oxide (LiMnO₂, LiMn₂O₄, or the like) as its main component, or a sputtering target including a lithium nickel oxide (LiNiO₂, LiNi₂O₄, or the like) as its main component. Alternatively, the positive electrode active material film 103 may be formed by a vacuum evaporation method.

In a sputtering method, using a metal mask enables the film to be deposited in a selected area. In addition, the positive electrode active material film 103 may be patterned by being selectively removed by dry etching or wet etching using a resist mask or the like.

The depositions of the positive electrode current collector film 101 and the positive electrode active material film 103 are preferably performed at a substrate temperature higher than 300° C., further preferably 400° C. or higher, still further preferably 500° C. or higher. Deposition at a high temperature enables the positive electrode 110 to have excellent crystallinity. In contrast, too high temperatures might soften the substrate, decrease the productivity, and so on. Accordingly, the substrate temperature for the deposition is preferably 1000° C. or lower, further preferably 700° C. or lower, still further preferably 650° C. or lower.

Next, the solid electrolyte 130 is formed over the positive electrode active material film 103 (S3). As a deposition method, a sputtering method, an evaporation method, or the like can be used. In a sputtering method, using a metal mask enables the film to be deposited in a selected area. In addition, the solid electrolyte 130 may be patterned by being selectively removed by dry etching or wet etching using a resist mask or the like.

Next, the negative electrode 150 is formed over the solid electrolyte 130 (S4). As a deposition method, a sputtering method, an evaporation method, or the like can be used. In a sputtering method, using a metal mask enables the film to be deposited in a selected area. In addition, the negative electrode 150 may be patterned by being selectively removed by dry etching or wet etching using a resist mask or the like.

Note that when the positive electrode 110 is formed by a sputtering method, at least one of the solid electrolyte 130 and the negative electrode 150 is preferably formed by a sputtering method. A sputtering apparatus is capable of successive film deposition in one chamber or using a plurality of chambers and can also be a multi-chamber manufacturing apparatus or an in-line manufacturing apparatus. A sputtering method is a manufacturing method that uses a chamber and a sputtering target and is suitable for mass production. In addition, a sputtering method enables a film to be thin and excels in film deposition properties.

Then, the protective layer 206 is preferably formed over the positive electrode 110, the solid electrolyte 130, and the negative electrode 150 (S5). A metal oxide containing one or more of hafnium, aluminum, gallium, yttrium, zirconium, tungsten, titanium, tantalum, nickel, germanium, neodymium, lanthanum, magnesium, and the like can be used as the protective layer 206. Moreover, silicon nitride oxide or silicon nitride can be used, for example. The protective layer 206 can be formed by a sputtering method.

For film deposition of each layer described in this embodiment, a gas phase method (a vacuum evaporation method, a thermal spraying method, a pulsed laser deposition method (PLD method), an ion plating method, a cold spray method, or an aerosol deposition method) can also be used without limitation to a sputtering method. The aerosol deposition (AD) method is a deposition method without heating a substrate. The aerosol means microparticles dispersed in a gas. In addition, a CVD method or an atomic layer deposition (ALD) method may be employed.

Through the above steps, the secondary battery 210 of one embodiment of the present invention can be manufactured.

This embodiment can be implemented in combination with any of the other embodiments.

### Embodiment 3

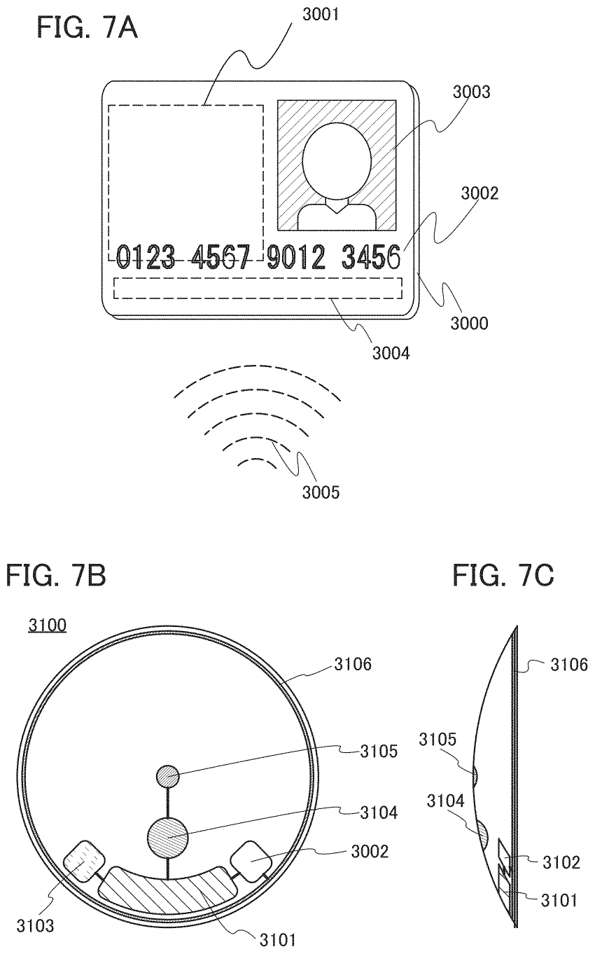

In this embodiment, electronic devices each including a secondary battery of one embodiment of the present invention are described with reference to FIGS. 7A to 7C, FIG. 8, and FIGS. 9A to 9C. The secondary battery of one embodiment of the present invention has high productivity, has high charge and discharge capacity, and high rate characteristics. Thus, the electronic devices can be inexpensive devices and can be used for a long time.

FIG. 7A illustrates an IC card 3000 that is an example of a device using a thin-film secondary battery of one embodiment of the present invention. A thin-film secondary battery 3001 can be charged with electric power fed from a radio wave 3005. An antenna, an IC 3004, and the thin-film secondary battery 3001 are provided inside an IC card 3000. On the IC card 3000, an ID 3002 and a photograph 3003 of an operator wearing the checking badge is displayed. A signal such as an authentication signal can be transmitted from the antenna using the electric power charged in the thin-film secondary battery 3001.

An active matrix display device may be provided to display the ID 3002 and the photograph 3003. Examples of the active matrix display device include a reflective liquid crystal display device, an organic EL display device, and electronic paper. An image (a moving image or a still image) and/or the time can be displayed on the active matrix display device. Electric power for the active matrix display device can be supplied from the thin-film secondary battery 3001.

A plastic substrate is used for the IC card, and thus an organic EL display device with a flexible substrate is preferable.

The IC card 3000 may include a solar battery. By irradiation with external light, light can be absorbed to generate electric power, and the thin-film secondary battery 3001 can be charged with the electric power.

FIGS. 7B and 7C each illustrate a contact lens 3100 including a thin-film secondary battery of one embodiment of the present invention. FIG. 7B and FIG. 7C are a top view and a side view, respectively, of the contact lens 3100.

The contact lens 3100 includes a thin-film secondary battery 3101, a control circuit 3102, and an antenna 3106. The contact lens 3100 may further include a sensor 3103, a camera 3104, and/or a light-emitting element 3105. The thin-film secondary battery 3101 can be charged with external electric power obtained through the antenna 3106. When the sensor 3103 and/or the camera 3104 is/are provided, data obtained by the sensor 3103 and/or the camera 3104 can be transmitted to an external device through the antenna 3106.

The sensor 3103 can have a function of measuring, for example, force, displacement, position, speed, acceleration, angular velocity, rotational frequency, distance, light, liquid, magnetism, temperature, chemical substance, sound, time, hardness, electric field, electric current, voltage, electric power, radiation, flow rate, humidity, gradient, oscillation, odor, or infrared rays. The light-emitting element 3105 can include, for example, an organic EL element.

Without limitation to the IC card, the thin-film secondary battery can be used for a power source of an in-vehicle wireless sensor, a secondary battery for a MEMS device, and the like.

FIG. 8 illustrates an example of a wearable device. A secondary battery may be used as a power source of the wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 400 illustrated in FIG. 8. The glasses-type device 400 includes a frame 400a and a display portion 400b. The secondary battery is provided in a temple of the frame 400a having a curved shape, whereby the glasses-type device 400 can be lightweight, can have a well-balanced weight, and can be used continuously for a long time. With the use of the secondary battery of one embodiment of the present invention, space saving required with downsizing of a housing can be achieved.

A secondary battery of one embodiment of the present invention can be provided in a headset-type device 401. The headset-type device 401 includes at least a microphone part 401a, a flexible pipe 401b, and an earphone part 401c. The secondary battery can be provided in the flexible pipe 401b or the earphone part 401c. With the use of the secondary battery of one embodiment of the present invention, space saving required with downsizing of a housing can be achieved.

The secondary battery of one embodiment of the present invention can be provided in a device 402 that can be attached directly to a body. A secondary battery 402b can be provided in a thin housing 402a of the device 402. With the use of the secondary battery of one embodiment of the present invention, space saving required with downsizing of a housing can be achieved.

The secondary battery of one embodiment of the present invention can be provided in a device 403 that can be attached to clothes. A secondary battery 403b can be provided in a thin housing 403a of the device 403. With the use of the secondary battery of one embodiment of the present invention, space saving required with downsizing of a housing can be achieved.

The secondary battery of one embodiment of the present invention can be provided in a belt-type device 406. The belt-type device 406 includes a belt portion 406a and a wireless power feeding and receiving portion 406b, and the secondary battery can be provided inside the belt portion 406a. With the use of the secondary battery of one embodiment of the present invention, space saving required with downsizing of a housing can be achieved.

The secondary battery of one embodiment of the present invention can be provided in a watch-type device 405. The watch-type device 405 includes a display portion 405a and a belt portion 405b, and the secondary battery can be provided in the display portion 405a or the belt portion 405b. With the use of the secondary battery of one embodiment of the present invention, space saving required with downsizing of a housing can be achieved.

The display portion 405a can display various kinds of information such as time, an e-mail and an incoming call.

In addition, the watch-type device 405 is a wearable device that is wound around an arm directly; thus, a sensor that measures the pulse, the blood pressure, or the like of the user may be incorporated therein. Data on the exercise quantity and health of the user can be stored to be used for health maintenance.

This embodiment can be implemented in appropriate combination with any of the other embodiments.

### Embodiment 4

A device described in this embodiment includes at least a biosensor and a solid-state secondary battery that supplies electric power to the biosensor, and can obtain various kinds of biological data using infrared light and visible light and make the memory store the data. Such biological data can be used for both user's personal authentication uses and health care uses. The secondary battery of one embodiment of the present invention has high productivity, high discharge capacity, and high safety. Thus, the device is an expensive and highly safe device and can be used for a long time.

The biosensor is a sensor for obtaining biological data and obtains biological data that can be used for health care. Examples of biological data include pulse waves, blood glucose levels, oxygen saturation levels, and neutral fat concentrations. The data is stored in the memory.

Furthermore, the device described in this embodiment is preferably provided with a unit for obtaining other biological data. Examples of such biological data include internal biological data such as an electrocardiogram, a blood pressure, and a body temperature and superficial biological data such as facial expression, a complexion, and a pupil. In addition, data on the number of steps taken, exercise intensity, a height difference in a movement, and a meal (e.g., calorie intake and nutrients) are important for health care. The use of a plurality of kinds of biological data and the like enables complex management of physical conditions, leading to not only daily health management but also early detection of injuries and diseases.

Blood pressure can be calculated from an electrocardiogram and a difference in timing of two pulsations of a pulse wave (a period of pulse wave propagation time), for example. A high blood pressure results in a short pulse wave propagation time, whereas a low blood pressure results in a long pulse wave propagation time. The body conditions of the user can be estimated from a relationship between the heart rate and the blood pressure that are calculated from the electrocardiogram and the pulse wave. For example, when both the heart rate and the blood pressure are high, it can be estimated that the user is nervous or excited, whereas when both the heart rate and the blood pressure are low, it can be estimated that the user is relaxed. When the state where the blood pressure is low and the heart rate is high is continued, the user might suffer from a heart disease or the like.

The user can check the biological data measured with the electronic device, one's own body conditions estimated on the basis of the data, and the like at any time; thus, health awareness is improved. This may inspire the user to reconsider the daily habits, for example, to avoid over-eating and over-drinking, get enough exercise, manage one's physical conditions, and have a medical examination at a medical institution as necessary.

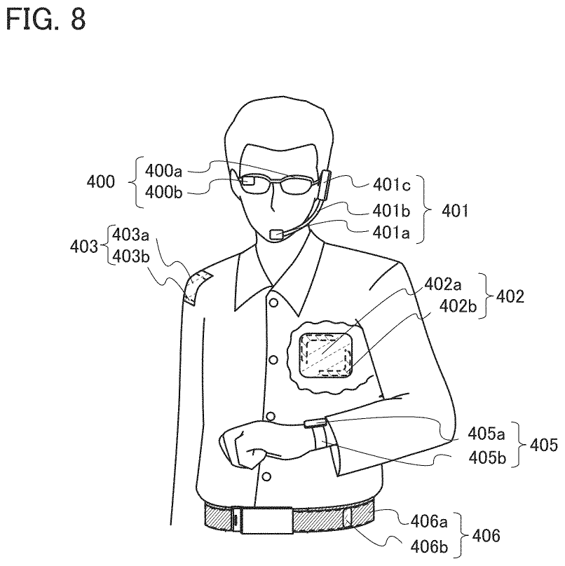

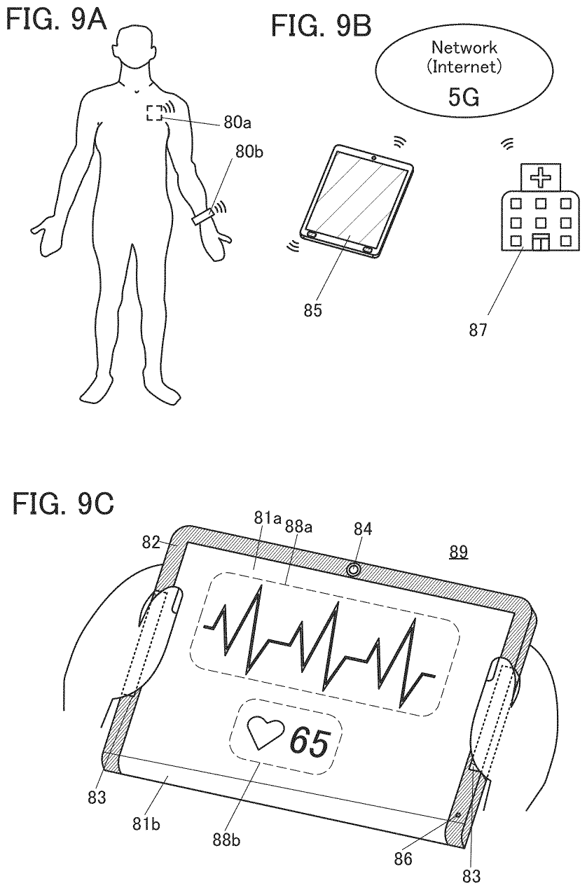

Data may be shared among a plurality of biosensors. FIG. 9A illustrates an example in which a biosensor 80a is embedded in a user's body and an example in which a biosensor 80b is worn on the user's wrist. Devices illustrated in FIG. 9A are, for example, a device including the biosensor 80a capable of electrocardiogram monitoring and a device including the biosensor 80b capable of heart rate monitoring by optical measurement of the pulse on the user's arm. Note that the wearable device such as a watch or a wristband illustrated in FIG. 9A is not limited to a heart rate meter, and a variety of types of biosensors can be used.

As the predetermined conditions of the embedded device illustrated in FIG. 9A, the device is small, hardly generates heat, and causes no allergic reaction or the like even when the device is in contact with the user's skin. The secondary battery used in the device of one embodiment of the present invention is preferable because it is small, hardly generates heat, and causes no allergic reaction or the like. The embedded device preferably incorporates an antenna so as to enable wireless charging.

The device embedded into the living body, which is illustrated in FIG. 9A, is not limited to the biosensor capable of electrocardiogram monitoring, and a biosensor capable of obtaining other biological data can be used.

The biosensor 80b incorporated in the device may temporarily store data in a memory incorporated in the device. Alternatively, the data obtained by the biosensor may be transmitted to a portable data terminal 85 in FIG. 9B with or without a wire, and waveforms may be detected in the portable data terminal 85. The portable data terminal 85 corresponds to a smartphone or the like and can detect whether or not a problem such as an irregular heartbeat occurs from the data obtained from the biosensors. In the case where the data obtained by the plurality of biosensors are transmitted to the portable data terminal 85 with a wire, it is preferable that the obtained data be collectively transmitted. Note that date may be automatically given to the detected data, and the data may be stored in a memory of the portable data terminal 85 and managed personally. Alternatively, the data may be transmitted to a medical institution 87 such as a hospital via a network (including the Internet) as illustrated in FIG. 9B. The data can be managed in a data server of the hospital and used as inspection data in treatment. Since medical data sometimes swells to a huge amount of data, an network including using a frequency band from 2.4 GHz to 2.4835 GHz, like Bluetooth (registered trademark), may be used for the data communication between the biosensor 80b and the portable data terminal 85, and the fifth-generation (5G) wireless system may be used for the high-speed data communication between the portable data terminal 85 and the medical institution 87. For the fifth-generation (5G) wireless system, frequency bands of the 3.7 GHz band, the 4.5 GHz band, and the 28 GHz band are used. With use of the fifth-generation (5G) wireless system, it becomes possible to obtain data and transmit the data to the medical institution 87, not only from home but also from the outside. As a result, data on poor physical conditions of the user can be accurately obtained and can be utilized for treatment performed later. Note that the portable data terminal 85 can have a structure illustrated in FIG. 9C.

FIG. 9C illustrates another example of a portable data terminal. A portable data terminal 89 includes a speaker, a pair of electrodes 83, a camera 84, and a microphone 86, in addition to a secondary battery.

The pair of electrodes 83 is provided in parts of a housing 82 with a display portion 81a therebetween. A display portion 81b is a curved region. The electrodes 83 function as electrodes for obtaining biological data.

Providing the pair of electrodes 83 in the longitudinal direction of the housing 82 as illustrated in FIG. 9C enables biological data to be obtained with the user being unconscious when the user uses the portable data terminal 89 with a landscape screen.

An example of the usage state of the portable data terminal 89 is illustrated. The display portion 81a can display electrocardiogram data 88a, heart-rate data 88b, and the like, which are obtained with the pair of electrodes 83.

This function is not necessary when the biosensor 80a is embedded in the user's body as illustrated in FIG. 9A. By contrast, when the biosensor 80a is not embedded, the user grasps the pair of electrodes 83 with the user's both hands, so that the electrocardiogram can be obtained. Even when the biosensor 80a is embedded in the user's body, the portable data terminal 89 illustrated in FIG. 9C can be used for comparing the electrocardiogram data with another user's in order to check whether the biosensor 80a operates normally.

The camera 84 can capture an image of the user's face, for example. Biological data on facial expression, a pupil, a complexion, and the like can be obtained from the image of the user's face.

The microphone 86 can obtain the user's voice. Voiceprint data that can be used for voiceprint authentication can be obtained from the obtained voice data. When voice data is regularly obtained and a change in voice quality is monitored, the voice data can be utilized for health management. Needless to say, talking on a video call with a doctor at the medical institution 87 is possible with use of the microphone 86, the camera 84, and the speaker.

With use of the device illustrated in FIG. 9A and the portable data terminal 89 illustrated in FIG. 9C, a remote medical support system can be achieved, in which data is transmitted from a remote area to a hospital to see a doctor.

This embodiment can be implemented in appropriate combination with any of the other embodiments.

### EXAMPLE

In this example, a positive electrode of one embodiment of the present invention was formed and its characteristics were analyzed. A secondary battery using the positive electrode was manufactured, and the characteristics were evaluated.

### <Fabrication of Sample 1>

First, the positive electrode 110 having the structure illustrated in FIG. 1B was fabricated as Sample 1. A glass substrate, titanium, titanium nitride, and lithium cobalt oxide were used as the substrate 100, the positive electrode current collector film 101a, the positive electrode current collector film 101b, and the positive electrode active material film 103, respectively

A 500-nm-thick titanium film was first formed as the positive electrode current collector film 101a over the glass substrate. The deposition conditions of the titanium film were as follows: the target was a titanium target, the argon partial pressure was 100%; the argon flow rate was 10 sccm; the pressure was 0.5 Pa; the electric power was 100 W (RF); the substrate-target distance was 75 mm; and the substrate temperature was 600° C.

Next, a 200-nm-thick titanium nitride film was formed as the positive electrode current collector film 101b. The deposition conditions of the titanium nitride film were as follows: the target was the titanium target; the argon partial pressure was 30%; the nitrogen partial pressure was 70%; the argon flow rate was 3 sccm; the nitrogen flow rate was 7 sccm; the pressure was 0.5 Pa; the electric power was 100 W (RF); the substrate-target distance was 75 mm; and the substrate temperature was 600° C.

Next, a 1000-nm-thick lithium cobalt oxide film was formed as the positive electrode active material film 103. The deposition conditions of the lithium cobalt oxide film were as follows: the target was a lithium cobalt oxide target; the argon partial pressure was 100%; the argon flow rate was 10 sccm; the pressure was 0.5 Pa; the electric power was 200 W (RF); the substrate-target distance was 75 mm; and the substrate temperature was 600° C.

The titanium film as the positive electrode current collector film 101a, the titanium nitride film as the positive electrode current collector film 101b, and the lithium cobalt oxide film as the positive electrode active material film 103 were all formed using a 28-mm-square mask. Thus, the volume of the lithium cobalt oxide film with a thickness of 1000 nm was approximately 0.000784 cm³.

### <Fabrication of Sample 2>

Sample 2 was fabricated to have the structure and materials that are the same as those of Sample 1. However, the positive electrode 110 was formed as Sample 2 under different conditions of the deposition temperatures of the titanium film, the titanium nitride film, and the lithium cobalt oxide film, and the thickness of the titanium nitride film.

The titanium film as the positive electrode current collector film 101a was formed under the same conditions as those of Sample 1, except that the deposition temperature was 300° C.

The titanium nitride film as the positive electrode current collector film 101b was formed under the same conditions as those of Sample 1, except that the thickness was 40 nm and the deposition temperature was 300° C.

The lithium cobalt oxide film as the positive electrode active material film 103 was formed under the same conditions as those of Sample 1, except that the deposition temperature was 300° C.

### <Fabrication of Sample 3>

To evaluate the orientation of the positive electrode current collector films, a titanium film and a titanium nitride film were formed over a glass substrate. This was used as Sample 3.

The titanium film was formed under the same conditions as those of Sample 1.

The titanium nitride film was formed under the same conditions as those of Sample 1, except that the thickness was 40 nm.

Table 1 shows the disposition conditions of Samples 1 to 3.

TABLE 1

| | | Deposition conditions | | |
|---|---|---|---|---|
| | Stacked structure | Material | Thickness (nm) | Temp. (° C.) |
| Sample 1 | Glass\Ti\TiN\LCO | LCO | 1000 | 600 |
| | | TiN | 200 | 600 |
| | | Ti | 500 | 600 |
| Sample 2 | Glass\Ti\TiN\LCO | LCO | 1000 | 300 |
| | | TiN | 40 | 300 |
| | | Ti | 500 | 300 |
| Sample 3 | Glass\Ti\TiN | TiN | 40 | 600 |
| | | Ti | 500 | 600 |

### <Thin Film XRD>

Out-of-plane thin film XRD measurement was performed on Samples 1 to 3 for evaluation of crystal structures and orientations thereof. D8 ADVANCE and D8 DISCOVER, produced by Bruker AXS, were used as the XRD measurement apparatus.

The measurement in using D8 ADVANCE had the following conditions.
XRD apparatus: D8 ADVANCE produced by Bruker AXS
X-ray source: CuKα₁ radiation
Output: 40 kV, 40 mA
Slit width: Div. Slit, 0.5°
Detector: LYNXEYE XE
Scanning method: 2θ/θ continuous scanning
Measurement range (2θ): from 15° to 80°
Step width (2θ): 0.01°
Counting time: 3 sec./step
Rotation of sample stage: 15 rpm

The measurement in the case of using D8 DISCOVER had the following conditions.
XRD apparatus: D8 DISCOVER produced by Bruker AXS
X-ray source: CuKα₁ radiation
Output: 50 kV, 100 mA
Slit width: 0.2 mm
Detector: Scintillation counter
Scanning method: 2θ/θ continuous scanning
Measurement range (2θ): from 15° to 80°
Step width (2θ): 0.01°
Counting time: 0.1 sec./step

In either case, the angle ψ was 0°.

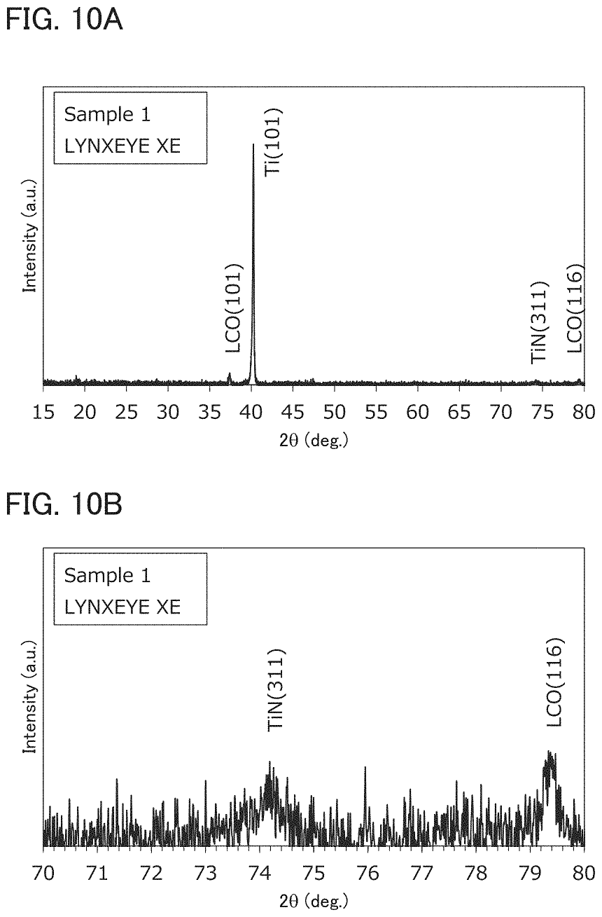

FIGS. 10A and 10B show XRD patterns of Sample 1. FIG. 10A shows the XRD pattern obtained when D8 ADVANCE and LYNXEYE XE as the detector were used, and FIG. 10B is a partial enlarged view of FIG. 10A.

As shown in FIGS. 10A and 10B, a peak derived from the (101) plane (space group P6₃/mmc) of the titanium film, a peak derived from the (101) plane (space group R-3m) in the lithium cobalt oxide film, a peak derived from the (311) plane (space group Fm-3m) of the titanium nitride film, and a peak derived from the (116) plane of the lithium cobalt oxide film were mainly observed. A peak derived from the (003) plane (2θ=approximately 18.5°) of the lithium cobalt oxide film was not clearly observed.

The peak derived from the (101) plane of the titanium film was observed at 2θ=approximately 40.2°. The peak derived from the (101) plane of the lithium cobalt oxide film was observed at 2θ=approximately 37.4°. The peak derived from the (311) plane of the titanium nitride film was observed at 2θ=approximately 74.1°. The peak derived from the (116) plane of the lithium cobalt oxide film was observed at greater than or equal to 77° and less than or equal to 81°, more specifically at 2θ=approximately 79.4°. Note that in this specification and the like, “approximately A degrees (A is a certain angle)” in an XRD pattern indicates that plus or minus 1.0° inclusive of A.

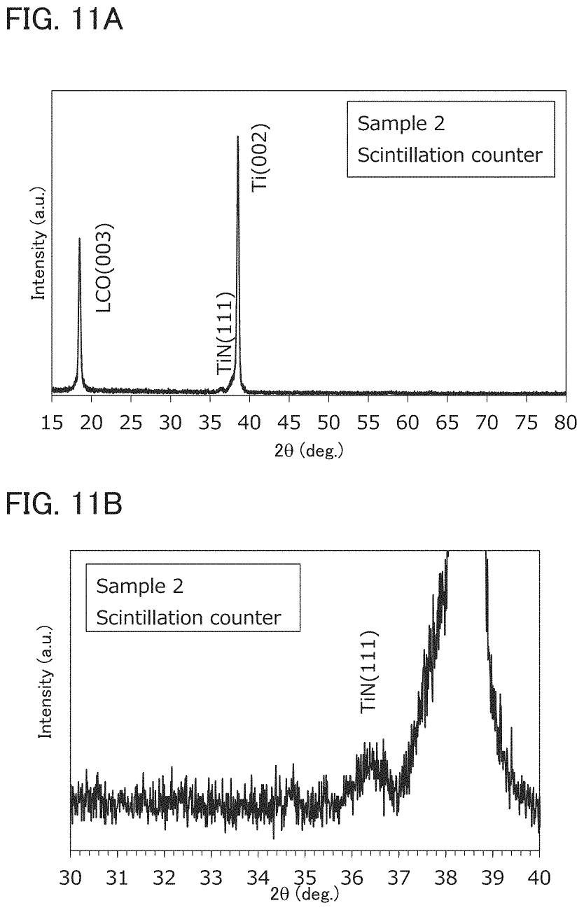

FIGS. 11A and 11B show XRD patterns of Sample 2. FIG. 11A shows the XRD pattern obtained when D8 DISCOVER and the scintillation counter as the detector were used, and FIG. 11B is a partial enlarged view of FIG. 11A. In Sample 2, a peak derived from the (002) plane of the titanium film was observed at 2θ=approximately 38.5°, a peak derived from the (003) plane of the lithium cobalt oxide film was observed at 2θ=approximately 18.5°, and a peak derived from the (111) plane of the titanium nitride film was observed at 2θ=approximately 36.4°.

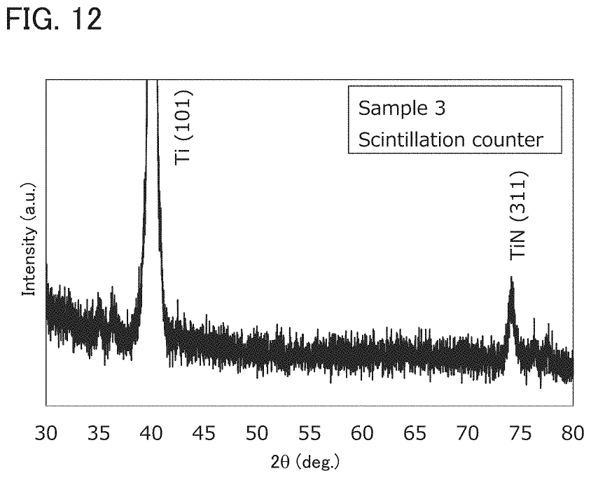

FIG. 12 shows an XRD pattern of Sample 3. FIG. 12 shows the XRD pattern obtained when D8 DISCOVER and the scintillation counter as the detector were used. In Sample 3, a peak derived from the (101) plane of the titanium film was observed at 2θ=approximately 40.2° and a peak derived from the (311) plane of the titanium nitride film was observed at 2θ=approximately 74.3°. This indicates the possibility that the titanium nitride film probably has the (311) orientation.

Moreover, wide-angle reciprocal space maps were obtained to evaluate the orientations of Samples 1 and 2 in details. D8 DISCOVER produced by Bruker AXS was used as an XRD measurement apparatus, in which case the X-ray source was CuKα₁, X ray output was 50 kV and 100 mA, and the diameter of the incident X ray was 0.3 to 0.5 mmφ). VANTEC-500 was used as the detector. The detector-stage distance was set to 150 mm.

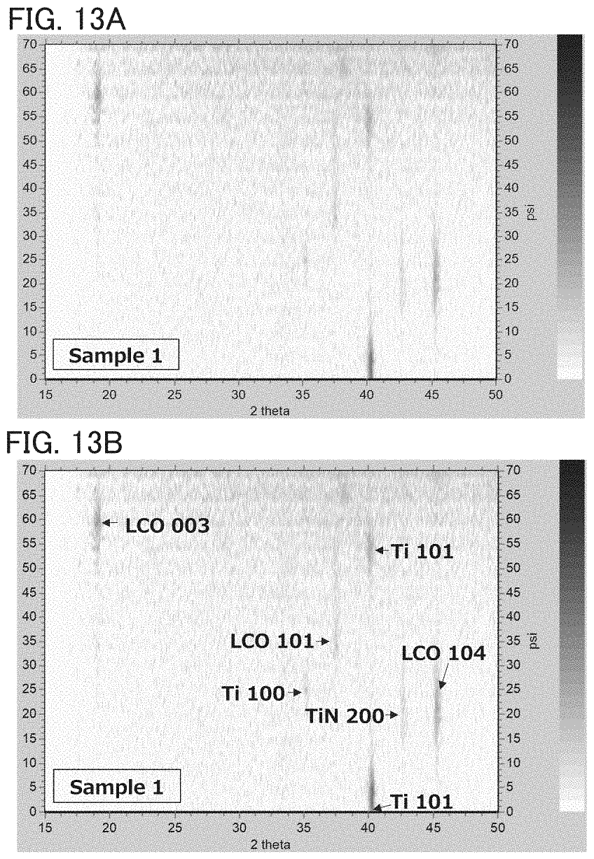

FIG. 13A shows the wide-angle reciprocal space map of Sample 1. FIG. 13B shows plane indices of the inverse lattice points obtained by peak analysis. Note that the inverse lattice points are shown up to psi=70°. Note that the inverse lattice points shown in the wide-angle reciprocal space map are representative examples and a bar over a number in Miller index is omitted in some cases.

As shown in FIGS. 13A and 13B, a plurality of spots were observed. The 003 spot of the lithium cobalt oxide film was observed in the range where the angle 2θ is greater than or equal to 17° and less than or equal to 21° and the angle ψ is greater than or equal to 45° and less than or equal to 70°. The 104 spot of the lithium cobalt oxide film was observed in the range where the angle 2θ is greater than or equal to 43° and less than or equal to 47° and the angle ψ is greater than or equal to 10° and less than or equal to 35°.

In FIG. 10A, the peak derived from the (101) plane of the lithium cobalt oxide film is detected; however, it was found that the 101 spot of the lithium cobalt oxide film were broad and thus detected in consideration of the result of FIG. 13B.

As apparent from FIGS. 10A and 10B, FIG. 12, FIG. 13B, and the wide-angle reciprocal space map obtained by calculation, Sample 1 has the (101) orientation of the titanium film, the (311) orientation of the titanium nitride film, and the (116) orientation of the lithium cobalt oxide film. In other words, the lithium cobalt oxide film in Sample 1 does not have a (003) orientation.

As illustrated in FIG. 13B, the titanium film has the (101) orientation but the 101 spot is broad, which demonstrated that the orientation is not so intensive.

The above reveals that Sample 1 is a positive electrode of one embodiment of the present invention, including a positive electrode active material film in which the lithium cobalt oxide film does not have (003) orientation. This is probably because the titanium nitride film as the positive electrode current collector film has the (311) orientation and the lithium cobalt oxide film is formed so as to have an orientation aligned with the orientation of the titanium nitride film accordingly.

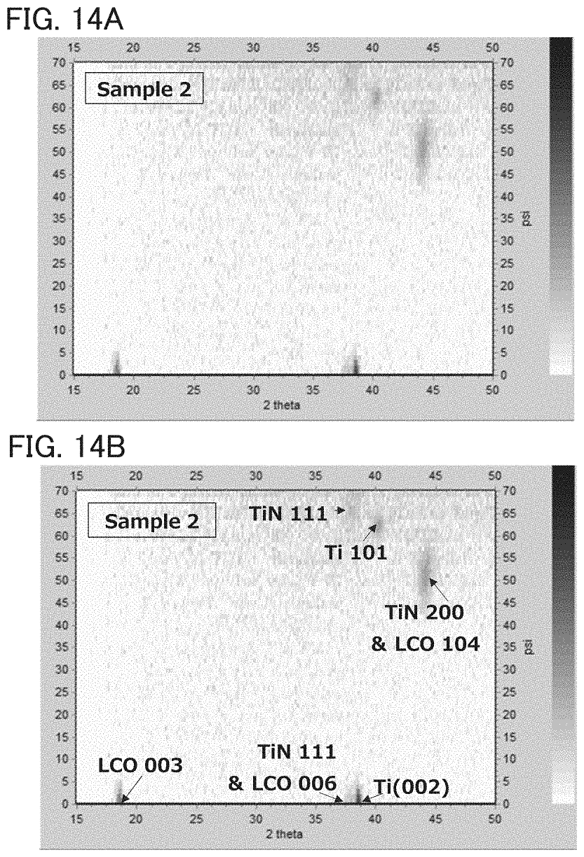

FIG. 14A shows the wide-angle reciprocal space map of Sample 2. Similarly, FIG. 14B shows plane indices of the inverse lattice points obtained by peak analysis. The 002 spot of titanium, the 111 spot of titanium nitride, and the 003 spot of lithium cobalt oxide were detected in the range where psi is greater than or equal to 0° and less than or equal to 15°.

As apparent from FIG. 14B, Sample 2 has the (002) orientation of the titanium film, the (111) orientation of the titanium nitride film, and the (003) orientation of the lithium cobalt oxide film

As described above, in Sample 2 in which deposition temperature of the titanium nitride film serving as the positive electrode current collector film was 300° C., the titanium nitride film had the (111) orientation and the lithium cobalt oxide film formed thereover serving as a positive electrode active material film had the (003) orientation.

On the other hand, it was found that in Sample 1 and Sample 3 in which deposition temperature of the titanium nitride film was 600° C., the titanium nitride film could have an orientation other than the (111) orientation. The result of Sample 1 also reveals that the lithium cobalt oxide film having the (116) orientation can be formed over the titanium nitride film having the (311) orientation.

### <Charge and Discharge Characteristics>

Secondary batteries were manufactured using the positive electrodes of Sample 1 and Sample 2 fabricated above.

A lithium metal was used for a counter electrode.

As the electrolytic solution, a solution in which ethylene carbonate (EC) and diethyl carbonate (DEC) were mixed at a volume ratio of 3:7 and 1.0 M lithium hexafluorophosphate (LiPF₆) was dissolved was used.

As a separator, a 25-μm-thick porous polypropylene film was used.

For an exterior body, an aluminum laminate film in which aluminum and polypropylene were stacked was used.

The charge and discharge characteristics of the secondary battery were evaluated. CCCV charging (0.2 mA, the upper-limit voltage of 4.2 V, the termination current of 0.05 mA) was performed and CC discharging (0.2 mA, the lower-limit voltage of 3 V) was performed. The temperature of measurement environment was 25° C.

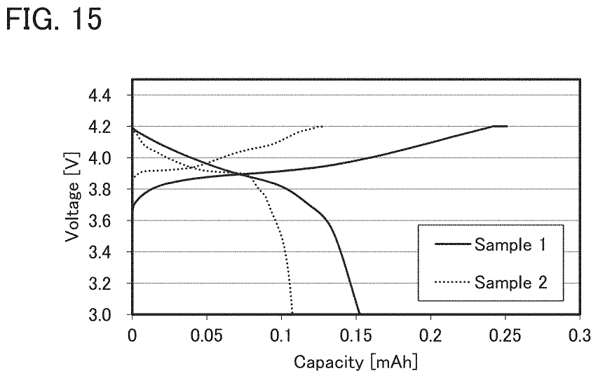

FIG. 15 shows initial charge and discharge curves. The discharging capacity of Sample 1 exceeded 0.13 mAh, specifically 0.152 mAh. In contrast, the discharging capacity of Sample 2 was 0.107 mAh

As described above, although Sample 1 and Sample 2 each have a 1000-nm-thick lithium cobalt oxide, Sample 1 in which the lithium cobalt oxide film did not have a (003) orientation exhibited a higher charge and discharge capacity than Sample 2 in which the lithium cobalt oxide film had the (003) orientation.

This application is based on Japanese Patent Application Serial No. 2021-210209 filed with Japan Patent Office on Dec. 24, 2021, the entire contents of which are hereby incorporated by reference.

What is claimed is:

1. A positive electrode formed over a first surface of a substrate, comprising:
a positive electrode current collector film over the first surface of the substrate; and
a positive electrode active material film over the positive electrode current collector film,
wherein the positive electrode active material film comprises a layered rock-salt crystal structure belonging to a space group R-3m, and
wherein a (00l) plane of the positive electrode active material film is not parallel to the first surface of the substrate.

2. The positive electrode according to claim 1,
wherein in an out-of-plane X ray diffraction of the positive electrode active material film, a (116) plane is observed in a range where an angle 2θ is greater than or equal to 77° and less than or equal to 81° and an angle ψ is greater than or equal to 0° and less than or equal to 5°.

3. The positive electrode according to claim 1,
wherein a crystal orientation of the positive electrode current collector film is aligned with a crystal orientation of the positive electrode active material film.

4. The positive electrode according to claim 1,
wherein the substrate is a glass substrate or a resin substrate.

5. The positive electrode according to claim 1,
wherein the positive electrode current collector film is a stacked layer of two or more kinds of films.

6. The positive electrode according to claim 5,
wherein the positive electrode current collector film is the stacked layer of a titanium film and a titanium nitride film, and
wherein the titanium film, the titanium nitride film, and the positive electrode active material film are formed in this order over the substrate.

7. The positive electrode according to claim 6,
wherein the titanium film comprises a crystal structure belonging to a space group P6₃/mmc and a (101) orientation,
wherein the titanium nitride film comprises a crystal structure belonging to a space group Fm-3m and a (311) orientation, and
wherein the positive electrode active material film comprises a (116) orientation.

8. The positive electrode according to claim 7,
wherein the positive electrode active material film comprises at least one of cobalt, nickel, and manganese.

9. A secondary battery comprising:
the positive electrode according to claim 7;
a solid electrolyte; and
a negative electrode.

10. An electronic device comprising;
the secondary battery according to claim 9;
an antenna; and
a charge and discharge circuit.

11. A positive electrode formed over a first surface of a substrate, comprising:
a positive electrode current collector film over the first surface of the substrate; and
a positive electrode active material film over the positive electrode current collector film,
wherein the positive electrode active material film comprises a layered rock-salt crystal structure belonging to a space group R-3m, and
wherein an angle between a (00l) plane of the positive electrode active material film and the first surface of the substrate is greater than 5°.

12. The positive electrode according to claim 11,
wherein in an out-of-plane X ray diffraction of the positive electrode active material film, a (116) plane is observed in a range where an angle 2θ is greater than or equal to 77° and less than or equal to 81° and an angle ψ is greater than or equal to 0° and less than or equal to 5°.

13. The positive electrode according to claim 11,
wherein a crystal orientation of the positive electrode current collector film is aligned with a crystal orientation of the positive electrode active material film.

14. The positive electrode according to claim 11,
wherein the substrate is a glass substrate or a resin substrate.

15. The positive electrode according to claim 11,
wherein the positive electrode current collector film is a stacked layer of two or more kinds of films.

16. The positive electrode according to claim 15,
wherein the positive electrode current collector film is the stacked layer of a titanium film and a titanium nitride film, and
wherein the titanium film, the titanium nitride film, and the positive electrode active material film are formed in this order over the substrate.

17. The positive electrode according to claim 16,
wherein the titanium film comprises a crystal structure belonging to a space group P6₃/mmc and a (101) orientation,
wherein the titanium nitride film comprises a crystal structure belonging to a space group Fm-3m and a (311) orientation, and
wherein the positive electrode active material film comprises a (116) orientation.

18. The positive electrode according to claim 17,
wherein the positive electrode active material film comprises at least one of cobalt, nickel, and manganese.

19. A secondary battery comprising:
the positive electrode according to claim 17;
a solid electrolyte; and
a negative electrode.

20. An electronic device comprising;
the secondary battery according to claim 19;
an antenna; and
a charge and discharge circuit.

21. A positive electrode formed over a first surface of a substrate, comprising:
a positive electrode current collector film over the first surface of the substrate; and
a positive electrode active material film over the positive electrode current collector film,
wherein in a wide-angle reciprocal space map of the positive electrode active material film, at least a first spot and a second spot are observed,
wherein a peak of the first spot is in a range where an angle 2θ is greater than or equal to 17° and less than or equal to 21° and an angle ψ is greater than or equal to 45° and less than or equal to 70°, and
wherein a peak of the second spot is in a range where an angle 2θ is greater than or equal to 43° and less than or equal to 47° and an angle ψ is greater than or equal to 10° and less than or equal to 35°.

22. The positive electrode according to claim 21,
wherein a crystal orientation of the positive electrode current collector film is aligned with a crystal orientation of the positive electrode active material film.

23. The positive electrode according to claim 21,
wherein the substrate is a glass substrate or a resin substrate.

24. The positive electrode according to claim 21,
wherein the positive electrode current collector film is a stacked layer of two or more kinds of films.

25. The positive electrode according to claim 24,
wherein the positive electrode current collector film is the stacked layer of a titanium film and a titanium nitride film, and
wherein the titanium film, the titanium nitride film, and the positive electrode active material film are formed in this order over the substrate.

26. The positive electrode according to claim 25,
wherein the titanium film comprises a crystal structure belonging to a space group P6₃/mmc and a (101) orientation,
wherein the titanium nitride film comprises a crystal structure belonging to a space group Fm-3m and a (311) orientation, and
wherein the positive electrode active material film comprises a (116) orientation.

27. The positive electrode according to claim 26,
wherein the positive electrode active material film comprises at least one of cobalt, nickel, and manganese.

28. A secondary battery comprising:
the positive electrode according to claim 26;
a solid electrolyte; and
a negative electrode.

29. An electronic device comprising;
the secondary battery according to claim 28;
an antenna; and
a charge and discharge circuit.
